(19) United States
(12) Patent Application Publication
(10) Pub. No.: US 2023/0203333 A1
(43) Pub. Date: Jun. 29, 2023

(54) PRINTABLE SUBSTRATE AND COATING COMPOSITION FOR PRINTING

(71) Applicant: NAN YA PLASTICS CORPORATION, Taipei (TW)

(72) Inventors: Te-Chao Liao, TAIPEI (TW); Wen-Cheng Yang, TAIPEI (TW); Ching-Yao Yuan, TAIPEI (TW); Yu-Chi Hsieh, TAIPEI (TW)

(73) Assignee: NAN YA PLASTICS CORPORATION, TAIPEI (TW)

(21) Appl. No.: 17/864,420

(22) Filed: Jul. 14, 2022

(30) Foreign Application Priority Data
Dec. 29, 2021 (TW) 110149266

(51) Int. Cl. C09D 11/54; C08J 7/04; C09D 11/104; C09D 11/30

(52) U.S. Cl. CPC C09D 11/54; C08J 7/042; C08J 7/0427; C09D 11/104; C09D 11/30; C08J 2467/00

(57) ABSTRACT

A printable substrate including a polymer substrate and a coating layer is provided. The coating layer covers the polymer substrate. The thickness of the coating layer is 0.1 μm to 30 μm. The surface impedance value of the coating layer is 10⁷ ohms to 10¹² ohms. The maximum printable temperature of the printable substrate is 100° C. to 190° C. After printing on the coating layer of the printable substrate, the result of an adhesion test for the printable substrate is 3B to 5B.

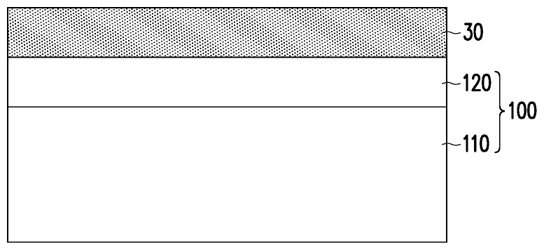

### CROSS-REFERENCE TO RELATED APPLICATION

This application claims the priority benefit of Taiwan application serial no. 110149266, filed on Dec. 29, 2021. The entirety of the above-mentioned patent application is hereby incorporated by reference herein and made a part of this specification.

### BACKGROUND

### Technical Field

The disclosure relates to a substrate and a coating composition, and particularly relates to a printable substrate and a coating composition for printing.

### Description of Related Art

The conventional lithographic, digital and/or inkjet printing is to print a pattern layer on wood pulp paper. However, to meet different needs (for example, water resistance, dust resistance, insect resistance, etc.), plastic paper is also required. Therefore, how to produce suitable plastic paper (for example, plastic paper suitable for printing or suitable for recycling) is the subject of current research.

### SUMMARY

The disclosure provides a coating composition for printing, which is suitable for producing a printable substrate.

The disclosure provides a printable substrate, which is suitable for printing.

A printable substrate according to the disclosure includes a polymer substrate and a coating layer. The coating layer covers the polymer substrate. A thickness of the coating layer is 0.1 μm to 30 μm. A surface impedance value of the coating layer is 10⁷ ohms to 10¹² ohms. A maximum printable temperature of the printable substrate is 100° C. to 190° C. After printing on the coating layer of the printable substrate, a result of an adhesion test for the printable substrate is 3B to 5B.

In an embodiment of the disclosure, the coating layer includes a polyester coating layer.

In an embodiment of the disclosure, the polymer substrate includes a polyester film substrate.

In an embodiment of the disclosure, the coating layer includes a polyester coating layer, the polymer substrate is a polyester film substrate, and the printable substrate is suitable for one-piece recycling in a state where the coating layer and the polymer substrate are not separated from each other.

A coating composition for printing according to the disclosure includes polyester resin, a cross-linking agent, particles, and an additive. Based on a weight of a specific unit of the coating composition for printing, the coating composition for printing includes: 50 wt % to 80 wt % of polyester resin, 0.05 wt % to 30 wt % of a cross-linking agent, 0.1 wt % to 30 wt % of particles, and 0.05 wt % to 10 wt % of an additive.

In an embodiment of the disclosure, a particle size of the particles is 0.05 μm to 3 μm.

In an embodiment of the disclosure, the coating composition for printing further includes a surface treatment agent.

In an embodiment of the disclosure, the coating composition for printing further includes a solvent.

In an embodiment of the disclosure, the coating composition for printing does not include polyurethane resin or acrylic resin.

A printable substrate according to the disclosure includes a polymer substrate and a coating layer formed by the coating composition for printing according to any of the foregoing embodiments. The coating layer covers the polymer substrate.

Based on the above, the coating composition for printing is suitable for producing the printable substrate, and the printable substrate is suitable for printing.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

The FIGURE is a schematic diagram of a printable substrate and its application according to an embodiment of the disclosure.

### DETAILED DESCRIPTION OF DISCLOSED EMBODIMENTS

In the following detailed description, for the sake of explanation and not limitation, exemplary embodiments revealing specific details are set forth to provide a thorough understanding of various principles of the invention. However, it will be apparent to those skilled in the art that, benefit from the disclosure, the invention may be practiced in other embodiments that depart from the specific details disclosed herein. In addition, descriptions of well-known devices, methods, and materials may be omitted so as not to obscure the description of various principles of the invention.

A range may be expressed herein as from “about” a specific value to “about” another specific value, and it may also be directly expressed as a specific value and/or to another specific value. When expressing the range, another embodiment includes from the one specific value and/or to another specific value. Similarly, when a value is expressed as an approximation by using the antecedent “about,” it will be understood that the specific value forms another embodiment. It will be further understood that an endpoint of each range is apparently related to or independent from another endpoint.

In the specification, non-limiting terms (such as possible, may, for example or other similar terms) are non-essential or optional implementation, inclusion, addition or existence.

Unless otherwise defined, all terms (including technical terms and scientific terms) used herein have the same meanings as commonly understood by those with ordinary knowledge in the technical field to which the invention belongs. It will also be understood that terms (such as those defined in commonly used dictionaries) should be interpreted as having a meaning consistent with the meaning in the relevant technical background and should not be interpreted in an idealized or overly formal sense, unless explicitly defined herein.

A coating composition for printing according to the disclosure is suitable to be coated on a surface of a substrate. Then, the coating composition for printing on the surface of the substrate may be cured by suitable means (for example, being heated, illuminated with light, placed still, or a combination of the foregoing (for example, being placed still after being heated)) to form a coating layer. The substrate and the coating layer on the surface of the substrate are suitable for printing. That is to say, referring to the FIGURE, a printable substrate 100 may include a coating layer 120 formed by the coating composition for printing as described above, and a substrate 110 as described above. A pattern layer 30 is suitable to be printed on the coating layer 120 by laser printing, UV printing, conventional lithographic printing, gravure printing, inkjet printing or other common printing methods.

In an embodiment, the aforementioned coating may include in-line coating or off-line coating.

The printable substrate is suitable for general printing. For example, the printable substrate may be printed using a commercially available printer or printing press.

In the present embodiment, a maximum printable temperature of the printable substrate may be 100° C. to 190° C., and according to an adhesion test (commonly known as the cross-cut test/pull-off test) carried out on the pattern layer printed on the coating layer by the standard test method of ASTM D3359, the result of the adhesion test for the printable substrate may be 3B to 5B. In other words, the printable substrate may be printed in a manner generally the same as or similar to paper printing.

In the present embodiment, the substrate may be a polymer substrate. For example, the substrate may include a polyester film substrate.

In an embodiment, the polyester material suitable for use as the substrate may include virgin polyester, recycled polyester or a combination of the foregoing. The former or latter polyester may also be, for example, polyethylene terephthalate, polytrimethylene terephthalate, polybutylene terephthalate, polyethylene naphthalate or a combination of the foregoing. In an embodiment, the polyester is preferably polyethylene terephthalate, polytrimethylene terephthalate or a combination of the foregoing. In addition, a copolymer may be used, particularly a copolymer obtained by using two or more dicarboxylic acids and/or two or more diol components.

In the present embodiment, a thickness of the coating layer is 0.1 μm to 30 μm.

In the present embodiment, the thickness of the substrate is substantially larger than the thickness of the coating layer. The thickness of the substrate may be adjusted according to the actual needs, which is not limited in the disclosure. For example, the thickness of the printable substrate (that is, the thickness of the substrate plus the thickness of the coating layer) may be about 0.01 cm to 0.015 cm for general printing on A4.

In the present embodiment, a surface impedance value of the coating layer is 10⁷ (can be expressed as 10\hat{ }7) ohms (ohm; Ω) to 10¹² (can be expressed as 10\hat{ }12) ohms. Therefore, when continuous printing is performed, paper jam is less likely to occur (but it does not mean that paper jam may be completely avoided).

In the present embodiment, the coating layer may include a polyester coating layer (that is, the used coating composition for printing may include polyester resin), and the polymer substrate is a polyester film substrate. Therefore, the printable substrate is suitable for a one-piece recycling step in a state where the coating layer and the substrate are not separated from each other.

In an embodiment, the aforementioned “one-piece recycling” includes the following, for example. Objects (for example, labels, needles, and/or stickers) on the waste printable substrate are removed. Next, in a state where the coating layer and the substrate are not separated from each other, the aforementioned waste polyester material is processed by physical means (for example, cutting, folding, shredding or other suitable means) to form a recycled mixture including the shredded polyester material; then, the shredded polyester material is separated by appropriate means (for example, flotation); and thereafter, the separated shredded polyester material may be dried to obtain a processed recycled polyester material. The recycled polyester material may be processed in a suitable manner (for example, see Taiwan Patent Application No. 110113065 and/or U.S. patent application Ser. No. 17/320,247) to form a suitable reusable polyester material.

In the present embodiment, based on a weight of a specific unit of the coating composition, the coating composition for printing includes 50 wt % to 80 wt % of polyester resin, 0.05 wt % to 30 wt % of a cross-linking agent, 0.1 wt % to 30 wt % of particles, and 0.05 wt % to 10 wt % of an additive.

In an embodiment, the aforementioned “a specific unit” is obtained by, for example, taking an appropriate volume or an appropriate weight of the coating composition; and then, subjecting the appropriate volume or the appropriate weight of the coating composition to measurement (for example, spectral measurement) of the ratios of the aforementioned components to obtain the weight ratios of the aforementioned components (for example, by calculation from the range of a specific spectral region). In an embodiment, the aforementioned “a specific unit” is obtained by, for example, taking an appropriate volume or an appropriate weight of the coating composition; then, partially or completely removing other specific components (that is, components other than the polyester resin, cross-linking agent, particles or additive, such as a solvent) in the appropriate volume or the appropriate weight of the coating composition (for example, partially or completely removing the solvent by heating); and thereafter, measuring the ratio of each of the aforementioned components in the mixture obtained after removing other specific components, so as to obtain the weight ratio of each of the aforementioned components. That is to say, in the coating composition for printing, the following components have the following weight ratios:

polyester resin: cross-linking agent:particle:additive ≈50 to 80:0.05 to 30:0.1 to 30:0.05 to 10.

In an embodiment, the polyester resin may be formed from one or more dibasic acids and one or more diols.

The dibasic acid may be an aromatic dibasic acid, a cycloaliphatic dibasic acid or a combination of the foregoing. The aromatic dibasic acid may include, for example, a terephthalic acid, an isophthalic acid, a phthalic acid, a naphthalene dicarboxylic acid, a diphenyl dicarboxylic acid, a diphenyl ether dicarboxylic acid, a diphenyl ketone dicarboxylic acid, a phenylindanedicarboxylic acid, a sodium isophthalate sulfonate, and a dibromoterephthalic acid. The other dibasic acid may include, for example, an oxalic acid, a succinic acid, an adipic acid, an azelaic acid, a sebacic acid or a dimer acid.

The diol may be an aromatic diol, an aliphatic diol, a cycloaliphatic diol or combination of the foregoing. The aromatic diol may include, for example, naphthalenediol, 2,2-bis(4-hydroxydiphenyl)propane, 2,2-bis(4-hydroxyethoxyphenyl)propane, bis(4-hydroxyphenyl)stilbene or hydroquinone. The aliphatic diol may include, for example, ethylene glycol, propylene glycol, 1,4-butanediol, hexanediol, neopentyl glycol or diethylene glycol. The cycloaliphatic diol may include, for example, cyclohexanedimethanol or cyclohexanediol.

In an embodiment, the polyester resin may be polyethylene terephthalate (PET), polypropylene terephthalate (PPT), polybutylene terephthalate (PBT), polyethylene naphthalate (PEN), polybutylene naphthalate (PBN), polycyclohexanedimethanol terephthalate (PCT), polycarbonate (PC), polyarylate or a combination of the foregoing. Preferably, the polyester resin may be polyethylene terephthalate (PET).

In an embodiment, the coating composition for printing does not include polyurethane resin or acrylic resin. In the case where the polyester film substrate is used as the substrate, if the coating composition for printing includes polyurethane resin or acrylic resin, it may increase the difficulty or complexity of recycling.

In an embodiment, the cross-linking agent may include melamine resin, melamine-modified resin, epoxy resin, a carbodiimide-based cross-linking agent, an oxazoline-based cross-linking agent or a combination of the foregoing.

In an embodiment, a particle size of the particles is 0.05 μm to 3 μm. The particle size of the particles is substantially smaller than the thickness of the correspondingly formed coating layer. If the particle size is larger than the thickness of the correspondingly formed coating layer, the obtained printable substrate may appear less flat.

In an embodiment, the particles may include organic particles, inorganic particles or a combination of the foregoing.

In an embodiment, the organic particles may include polymer particles or copolymer particles formed from the following monomers: styrenics (such as styrene, vinylbenzene or chlorostyrene), monoolefins (such as ethylene, propylene, butylene or isobutylene), alkenyl esters (such as vinyl acetate, vinyl propionate, vinyl benzoate, vinyl butyrate, methyl acrylate, ethyl acrylate or butyl acrylate), alkenyl ethers (such as vinyl methyl ether, vinyl ethyl ether or vinyl butyl ether), vinyl ketones (such as vinyl methyl ketone or vinyl hexyl ketone), diene monomers (such as isoprene) or a combination of the foregoing.

In an embodiment, a material of the inorganic particles may include mica, talc, magnesium carbonate, calcium carbonate, barium carbonate, barium sulfate, calcium sulfate, magnesium sulfate, zinc oxide, silicon dioxide, titanium dioxide, aluminum oxide or a combination of the foregoing.

In an embodiment, the particles may improve the bonding force between the pattern layer and the coating layer.

In an embodiment, the particles may reduce paper jam.

In an embodiment, the additive may include a catalyst, a co-solvent, an adjuvant or a combination of the foregoing.

In an embodiment, the catalyst nay increase the reaction rate of the coating composition for printing when cured. The catalyst may include an inorganic substance, salts, an organic substance, a basic substance, an acidic substance or a combination of the foregoing.

In an embodiment, the co-solvent may control the volatilization rate of the liquid component when the coating composition for printing is cured. The co-solvent may include methanol, ethanol, n-propanol, isopropanol, isobutanol, butyl cellulose or a combination of the foregoing.

In an embodiment, the adjuvant may improve the wettability and/or flatness of the formed coating layer. The adjuvant may include a silicon adjuvant, a fluorine adjuvant, a silicon-fluorine adjuvant or a combination of the foregoing. The silicon adjuvant may be selected from Model No. BYK307, BYK325, BYK331, BYK380N or BYK381 produced by BYK-Gardner Gmbh, or one or more of the aforementioned adjuvant products. The fluorine adjuvant may be selected from Model No. FC-4430 or FC-4432 produced by 3M; Model No. Zonyl FSN-100 produced by DuPont; Model No. DSX produced by Daikin Industries, Ltd.; or one or more of the aforementioned adjuvant products. The silicon-fluoride adjuvant may be selected from Model No. BYK346, BYK347, or BYK348 produced by BYK-Gardner Gmbh, or one or more of the aforementioned adjuvant products.

In an embodiment, the coating composition for printing may further include a solvent. The solvent may include methyl ethyl ketone (MEK), toluene or a combination of the foregoing.

In an embodiment, the coating composition for printing further may include a surface treatment agent. The surface treatment agent may include a silicon-containing compound, a surfactant or a combination of the foregoing.

In an embodiment, the silicon-containing compound may include a silane compound, a polysilane compound or a combination of the foregoing.

In an embodiment, the surfactant may include an anionic surfactant, a nonionic surfactant or a combination of the foregoing.

In an embodiment, the anionic surfactant may be selected from ammonium methylbenzene sulfate, ammonium polyethylene glycol nonphenol ether sulfate, sodium polyethylene glycol nonphenol ether sulfate, polyethylene glycol octyl ether ammonium salt or condensed polyethylene glycol polycyclic nonyl phenol ether methacrylate sulfate produced by SINO-JAPAN Chemical Co., Ltd.; Model No. Maxemul 6106 or 6112 produced by Uniqema; or one or more of the aforementioned surfactants.

In an embodiment, the nonionic surfactant may be selected from polyethylene glycol nonanol ether or polyethylene glycol alkyl ether produced by Pan Asia Chemical Corporation; polyethylene glycol stearate, polyethylene glycol nonyl ether, polyethylene glycol octyl ether, polyethylene glycol decyl ether, polyethylene glycol tridecyl ether or polyethylene glycol lauryl ether produced by SINO-JAPAN Chemical Co., Ltd.; Model No. Maxemul 5010 or 5011 produced by Uniqema; or one or more of the aforementioned surfactants.

In conclusion, the printable substrate according to the disclosure has favorable printability. The printable substrate according to the disclosure is more suitable for recycling or easier to be recycled.

### EXAMPLES AND COMPARATIVE EXAMPLES

The following examples and comparative examples are shown to specifically describe the disclosure, but the disclosure should not be construed as being limited by the following examples.

In each of the examples and comparative examples, a corresponding printable substrate can be formed using the corresponding coating composition for printing by the method described above. The difference between them lies in that: the relative weight ratios of the corresponding components (such as the resin, cross-linking agent, solvent, surface treatment agent, filler particles or additive) in each coating composition for printing were adjusted as shown in the following [Table 1].

The printable substrates of [Example 1] to [Example 4] and [Comparative Example 1] to [Comparative Example 4] in [Table 1] were evaluated. The items evaluated include coating layer appearance, polyester coating layer, water resistance, printing effect, color ink adhesion, and continuous printing test.

Coating layer appearance: The coating layer appearance of the corresponding printable substrate is observed in a strong light environment by human vision. If there is no abnormality in the visual evaluation, the evaluation is good.

Polyester coating layer: Whether the polyester coating layer is present is evaluated. YES is represented by the symbol ∘; and NO is represented by the symbol X.

Water resistance test 1: The corresponding printable substrate is cut into A4 standard size, and soaked in water for 24 hours after full page printing, which is then compared with the aforementioned full-page printing to observe whether the color ink is smeared. Water resistance test 2: The corresponding printable substrate is cut into A4 standard size, and after full page printing, the printing surface is wiped 10 times with wet tissue, which is then compared with the aforementioned full-page printing to observe whether the color ink falls off. If the test result of the above water resistance test 1 shows that the color ink is not smeared, and the test result of the above water resistance test 2 shows that the color ink does not fall off, the evaluation is good; otherwise (that is, it does not meet one of the above test results), the evaluation is poor.

Printing effect: A commercially available printing machine is used to perform full page printing on the corresponding printable substrate to observe whether the color ink can completely cover the coating layer. The printing machine may be, but not limited to, a conventional lithographic printing machine, a digital inkjet printing machine HP 5800, a digital electronic ink printing machine HP Indigo series, or a dry powder laser printer HP CP1000 series. If the color ink may completely cover the coating layer, the evaluation is good. If the color ink does not completely cover the coating layer, the evaluation is poor.

Color ink adhesion test 1: After performing full page printing on the corresponding printable substrate, 3M Scotch tape is stuck to a printed area, and the tape is pressed five times with fingers to strengthen the adhesion to the film surface; and then, the tape is quickly pulled off to observe whether the printed color ink falls off. Color ink adhesion test 2: The ASTM (American Society for Testing and Materials) D3359 adhesion test standard is adopted to test the corresponding printable substrate. If the test result of the above color ink adhesion test 1 shows that the color ink does not fall off at all, and the test result of the above color ink adhesion test 2 is 3B to 5B, the evaluation is good; otherwise (that is, it does not meet one of the above test results), the evaluation is poor.

Continuous printing test 1: The corresponding printable substrate is printed in full page continuously for 10 times. Continuous printing test 2: The corresponding printable substrate is printed in blank continuously for 10 times. Continuous printing test 3: The corresponding printable substrate is printed in full page/blank alternately for 5 times. If the test result of the above continuous printing test 1 shows that no paper jam occurs at all, the test result of the above continuous printing test 2 shows that no paper jam occurs at all, and the test result of the above continuous printing test 3 shows that no paper jam occurs at all, the evaluation is good; otherwise (that is, it does not meet one of the above test results), the evaluation is poor.

TABLE 1

| | | Exam- | Exam- | Exam- | Exam- | Com- | Com- | Com- | Com- |
|---|---|---|---|---|---|---|---|---|---|
| | | ple | ple | ple | ple | parative | parative | parative | parative |
| Component | | 1 | 2 | 3 | 4 | Example 1 | Example 2 | Example 3 | Example 4 |
| Resin | Polyurethane | 0 | 0 | 0 | 0 | 0 | 20 | 0 | 20 |
| | resin | | | | | | | | |
| | Acrylic resin | 0 | 0 | 0 | 0 | 0 | 8 | 0 | 8 |
| | Polyester resin | 20 | 20 | 45 | 10 | 20 | | 20 | |
| Cross-linking | Melamine | 1.00 | 0 | 1.5 | 0.25 | 0 | 5 | 1.00 | 1.00 |
| agent | based | | | | | | | | |
| | Epoxy resin | 0 | 1.00 | 1.2 | 0.25 | 0 | 3 | 0.5 | 0.5 |
| | based | | | | | | | | |
| Solvent | MEK or toluene | 62.32 | 62.32 | 25.24 | 80.89 | 62.17 | 63.37 | 62.32 | 62.32 |
| Surface | Surfactant A | 0.1 | 0.1 | 0.2 | 0.05 | 0.1 | 0.1 | 0 | 0.1 |
| treatment | Surfactant B | 0.25 | 0.25 | 0.5 | 0.1 | 0.25 | 0.25 | 0 | 0.25 |
| agent | Silicon | 0.1 | 0.05 | 0.2 | 0.1 | 0.1 | 0.1 | 0 | 0.1 |
| | containing | | | | | | | | |
| | compound | | | | | | | | |
| Filler | Particle C | 1.6 | 2.1 | 3.2 | 0.8 | 1.6 | 1.6 | 1.6 | 0 |
| particles | (size about | | | | | | | | |
| | 2 μm) | | | | | | | | |
| | Particle D | 3.6 | 2.5 | 7.2 | 2 | 3.6 | 3.6 | 3.6 | 0 |
| | (size about | | | | | | | | |
| | 0.1 μm) | | | | | | | | |
| Additive | Catalyst | 0.10 | 0.10 | 0.2 | 0.10 | 0.10 | 0.10 | 0.10 | 0.10 |
| | Butyl cellulose | 1.2 | 1.2 | 2.4 | 0.6 | 1.2 | 1.2 | 1.2 | 1.2 |
| | Silicon | 0.03 | 0.03 | 0.06 | 0.01 | 0.03 | 0.03 | 0.03 | 0.03 |
| | adjuvant or | | | | | | | | |
| | fluorine | | | | | | | | |
| | adjuvant | | | | | | | | |
| Property item | Coating layer | good | good | good | good | good | good | with coating | good |
| | appearance | | | | | | | pattern | |
| | Polyester | ◯ | ◯ | ◯ | ◯ | ◯ | X | ◯ | X |
| | coating layer | | | | | | | | |
| | Water | good | good | good | good | good | good | good | good |
| | resistance | | | | | | | | |
| | Printing effect | good | good | good | good | good | good | good | poor |
| | Color ink | good | good | good | good | poor | good | good | good |
| | adhesion | | | | | | | | |
| | Continuous | good | good | good | good | good | good | good | poor |
| | printing test | | | | | | | | |

As shown in the above [Examples], the printable substrate according to the disclosure has favorable printability.

### INDUSTRIAL APPLICABILITY

The coating composition for printing according to the disclosure is suitable for producing a printable substrate. In addition, the printable substrate according to the disclosure is suitable for application in conventional lithographic printing, digital printing and/or inkjet printing.

1. A printable substrate, comprising:
a polymer substrate; and
a coating layer covering the polymer substrate, wherein:
a thickness of the coating layer is 0.1 μm to 30 μm;
a surface impedance value of the coating layer is 10⁷ ohms to 10¹² ohms;
a maximum printable temperature of the printable substrate is 100° C. to 190° C.; and
after printing on the coating layer of the printable substrate, a result of an adhesion test for the printable substrate is 3B to 5B.

2. The printable substrate according to claim 1, wherein the coating layer comprises a polyester coating layer.

3. The printable substrate according to claim 1, wherein the polymer substrate comprises a polyester film substrate.

4. The printable substrate according to claim 1, wherein:
the coating layer comprises a polyester coating layer;
the polymer substrate is a polyester film substrate; and
the printable substrate is suitable for one-piece recycling in a state where the coating layer and the polymer substrate are not separated from each other.

5. A coating composition for printing, wherein based on a weight of a specific unit of the coating composition for printing, the coating composition for printing comprising:
50 wt % to 80 wt % of polyester resin;
0.05 wt % to 30 wt % of a cross-linking agent;
0.1 wt % to 30 wt % of particles; and
0.05 wt % to 10 wt % of an additive.

6. The coating composition for printing according to claim 5, wherein a particle size of the particles is 0.05 μm to 3 μm.

7. The coating composition for printing according to claim 5, further comprising:
a surface treatment agent.

8. The coating composition for printing according to claim 5, further comprising:
a solvent.

9. The coating composition for printing according to claim 5, excluding:
polyurethane resin; or
acrylic resin.

10. A printable substrate, comprising:
a polymer substrate; and
a coating layer formed by a coating composition for printing, the coating layer covering the polymer substrate, wherein based on a weight of a specific unit of the coating composition for printing, the coating composition for printing comprising:
50 wt % to 80 wt % of polyester resin;
0.05 wt % to 30 wt % of a cross-linking agent;
0.1 wt % to 30 wt % of particles; and
0.05 wt % to 10 wt % of an additive.

11. The printable substrate according to claim 10, wherein a particle size of the particles is 0.05 μm to 3 μm.

12. The printable substrate according to claim 10, further comprising:
a surface treatment agent.

13. The printable substrate according to claim 10, further comprising:
a solvent.

14. The printable substrate according to claim 10, excluding:
polyurethane resin; or
acrylic resin.
